(19) United States
(12) Patent Application Publication
(10) Pub. No.: US 2026/0274454 A1
(43) Pub. Date: Sep. 17, 2026

(54) BODY SEALING APPROACH TO ENABLE PRESSURIZED PARTIAL SPACE SUIT OPERATIONS

(71) Applicant: Atlas Devices LLC, Chelmsford, MA (US)

(72) Inventors: Nathan Ball, Forest Grove, OR (US); Daniel Walker, Melrose, MA (US)

(21) Appl. No.: 19/681,760

(22) Filed: May 19, 2026

Related U.S. Application Data
(63) Continuation of application No. PCT/US24/56779, filed on Nov. 20, 2024.
(60) Provisional application No. 63/601,012, filed on Nov. 20, 2023.

(51) Int. Cl. B64G 6/00

(52) U.S. Cl. CPC B64G 6/00

(57) ABSTRACT

A pressurized partial space suit comprising: a pressurizable air-tight enclosure configured to be positioned on a body part of a user, the pressurizable air-tight enclosure having a proximal end and a distal end; a seal configured to seal the pressurizable air-tight enclosure to the user, the seal comprising: a flexible lip seal configured to circumscribe the body part of the user, the flexible lip seal configured to seal the pressurizable air-tight enclosure the body part of the user to maintain a pressure inside the pressurizable air-tight enclosure; a connectable seal housing having a connector in fluidic communication with the pressurizable air-tight enclosure to maintain the pressure in the pressurizable air-tight enclosure, wherein: the flexible lip seal is inward of the seal housing; and the pressurizable air-tight enclosure s removably attached to the seal.

### CROSS-REFERENCE TO RELATED APPLICATIONS

This patent application is a continuation application of International Patent Application No. PCT/US2024/056779, filed on November 20, 2024, entitled “BODY SEALING APPROACH TO ENABLE PRESSURIZED PARTIAL SPACE SUIT OPERATIONS,” and naming Nathan Ball and Daniel Walker as inventors , which claims priority from provisional United States patent application number 63/601,012, filed November 20, 2023, entitled, “Body Sealing Approach to Enable Pressurized Partial Space Suit Operations,” and naming Nathan Ball and Daniel Walker as inventors, the disclosure of each of which are incorporated herein, in their entirety, by reference.

### FIELD

Illustrative embodiments of the invention generally relate to partial space suits and, more particularly, various embodiments of the invention relate to pressurized partial space suits for training physical mobility and dexterity.

### BACKGROUND

A defining attribute of Extravehicular Activities (EVAs) is the hindrance the pressurized space suit places on physical mobility and dexterity, especially in the gloves. The effort required to repeatedly flex and extend the fingers while fighting the pressure of the suit is a key driver for the design of any system a crewmember may physically interact with in spaceflight while wearing a pressure suit. To simulate the experience of manipulating crew systems, tools, and mechanical user interfaces from within a pressurized suit, negative pressure glove boxes are the most frequently used tool. These glove boxes create the same pressure differential between the glove and ambient environment around it, typically around 4 PSI (e.g, pounds per square inch), by sealing the gloves in a pressure vessel and pulling a vacuum to the desired pressure differential. For example, in a typical use case, the glove box would enclose the gloves, which are sealed around the gauntlet such that the interior of the glove is at ambient room pressure, and the exterior of the glove is exposed to the enclosed pressure volume on which the vacuum is pulled. When a user puts their hands into the gloves and flexes or extends their fingers, the pressure difference between the ambient room, typically 14.7 PSI absolute, and the partial vacuum pulled around the gloves exterior, typically 10.3 PSI absolute, yields the same difficulty as when the user is in a full pressure suit that is pressurized to 19.0 PSI because in each case the pressure on the inside of the glove is 4.3 PSI higher than the pressure on the outside of the glove.

Despite the accuracy that can be achieved with this approach, typical glove boxes come with significant limitations, including that: 1) the systems are not easily portable, 2) the volume of the chamber is internal-only and limits the size of objects or systems that can be inserted, and 3) because the location of the upper arms is fixed, users cannot manipulate objects or systems within the box with the additional dexterity they would have in a full space suit that includes shoulder joints. These challenges are overcome by fully suited testing. Undesirably, full suited testing has high cost and overhead issues.

### SUMMARY OF VARIOUS EMBODIMENTS

In accordance with one embodiment of the invention, a pressurized partial space suit includes a pressurizable air-tight enclosure configured to be positioned on a body part of a user. The pressurizable air-tight enclosure has a proximal end and a distal end.

The pressurizable air-tight enclosure also includes a seal configured to seal the pressurizable air-tight enclosure to the user. The seal includes a flexible lip seal that circumscribes or encircles the body part of the user, and the flexible lip seal is configured to seal the proximal end of the pressurizable air-tight enclosure to a proximal portion of the body part of the user to maintain a pressure inside the pressurizable air-tight enclosure.

The pressurizable air-tight enclosure also includes a removably connectable seal housing having a connector in fluidic communication with the pressurizable air-tight enclosure to maintain the pressure in the pressurizable air-tight enclosure. The flexible lip seal is inward of the seal housing, and the pressurizable air-tight enclosure is removably attached to the seal. The distal end of the pressurizable air-tight enclosure may be enclosed. The connector may be an air inlet.

The seal may be a first seal . The pressurized partial space suit may further include a second seal on the distal end of the pressurizable air-tight enclosure. The second seal may be configured to seal the distal end of the pressurizable air-tight enclosure to a distal portion of the body part of the user to maintain the pressure inside the pressurizable air-tight enclosure. The flexible lip seal may include a sleeve comprising a compliant solid material.

The pressurized partial space suit may have a pressure between 3 PSI and 15 PSI. The pressure may be between 3.5 PSI and 5.5 PSI.

The pressurized partial space suit may further include an axial restraint configured to be attached to the seal via attachment straps such that the axial restraint retains the pressurizable air-tight enclosure on the body part of the user.

In some embodiments, the body part is an arm. The distal end of the pressurizable air-tight enclosure may include a glove, or a second seal. The proximal end of the pressurizable air-tight enclosure may be configured to form a seal with a portion of the arm between an elbow and a shoulder of the user, or between an elbow and a wrist of the user. In some embodiments, the axial restraint may be a shoulder brace.

In some embodiments, body part is a leg. The distal end of the pressurizable air-tight enclosure may be a boot, or a second seal. The proximal end of the pressurizable air-tight enclosure may be configured to form a seal with a portion of the leg between a knee and a hip of the user, or between the knee and an ankle of the user. The axial restraint may be a hip brace.

The seal may include one or more bearings. The one or more bearings may include one or more ball bearings.

In accordance with one embodiment of the invention, a seal includes a seal housing. The seal housing forms a circular structure.

The seal also includes a flexible lip seal configured to circumscribe a body part of the user. The flexible lip seal is inward of the seal housing and is configured to seal an end of a pressurizable air-tight enclosure to a portion of the body part of the user to maintain a pressure inside the pressurizable air-tight enclosure.

The seal also includes a soft goods clamp. The soft good clamp is configured to retain a flexible portion of the pressurizable air-tight enclosure.

The seal also includes a bearing inner race, and the bearing inner race includes one or more ball bearings.

The seal also includes a bearing outer race, and the bearing inner race includes one or more ball bearings.

The seal also includes an air inlet. The air inlet is configured to enable fluidic communication between an air source and the pressurizable air-tight enclosure. The soft goods clamp, the bearing inner race, the bearing outer race, the air inlet, and the flexible lip seal are configured to fit together to form the seal. The air inlet may include a valve.

The seal may further include one or more restraint strap attachment brackets. The seal may further include one or more straps and connectors.

The flexible lip seal may include two or more ribs, a lip, and a retaining feature. The retaining structure configured to prevent the flexible lip seal from being expelled from the seal when the pressurized partial space suit is pressurized.

### BRIEF DESCRIPTION OF THE DRAWINGS

Those skilled in the art should more fully appreciate advantages of various embodiments of the invention from the following “Description of Illustrative Embodiments,” discussed with reference to the drawings summarized immediately below.

FIG. 1A shows an embodiment of pressurized partial space suit positioned on an arm of a user according to an embodiment of the present disclosure.

FIG. 1B shows an embodiment of pressurized partial space suit positioned on a leg of a user according to an embodiment of the present disclosure.

FIG. 2A shows an embodiment of pressurized partial space suit according to an embodiment of the present disclosure.

FIG. 2B shows a disassembled prototype illustrating a pressure-tight inner structure and an outer fabric covering according to an embodiment of the present disclosure.

FIG. 3A shows an embodiment of a seal according to an embodiment of the present disclosure.

FIG. 3B shows a section view of the seal according to an embodiment of the present disclosure.

FIG. 4 shows the seal with ribs that help prevent inversion when pressurized according to an embodiment of the present disclosure.

FIG. 5 shows a block diagram of the first prototype glove simulation system according to an embodiment of the present disclosure.

FIG. 6 shows a block diagram for the second prototype glove simulation prototype system according to an embodiment of the present disclosure.

FIG. 7 shows a photograph of a clear plastic tube attachment with a custom pressure seal and a subject’s arm according to an embodiment of the present disclosure.

### DESCRIPTION OF ILLUSTRATIVE EMBODIMENTS

Illustrative embodiments present a partial space suit to simulate the experience of manipulating crew systems, tools, and mechanical user interfaces from within a pressurized suit. Some embodiments, internally seal the arms of a space suit directly against suited wearer's skin, enabling mobile operations in either shirt sleeves or in space suit mockups. Favorably, various embodiments also include the added realism of pressurized gloves and lower arms without bringing along the challenge, difficulty, and risk of full pressure suit operations.

Some embodiments of the system may seal the partial suit against the wearer's body, allowing for pressurized extremities, interfaces compatible with spaceflight hardware such as space suit bladder layers, restraint layers, outer thermal micrometeoroid garments (e.g., TMGs), and hard interface hardware such as wrist, ankle, arm or leg disconnects. The described approach of sealing to the body is useful for the arms and especially hands, since the pressure in the gloves has such a significant impact on dexterity. However, the approach may also be used for any other part of the body, such as sealing around the upper legs or the torso to enable the pressurization of suit only from the seal location down to the bottom of the feet. When implemented in a mockup space suit as an example, users are expected to gain a significantly improved simulated suit experience due to the additional load bearing of the suit's weight that results from the pressure in the legs helping to hold the suit up off the ground. Another benefit of sealing the partial suit against the wearer's body for specific parts of the body versus donning a full suit is that the challenge and safety concerns that arise from having a person fully sealed inside the suit and that person being dependent on the ventilation and pressurization profile. Details of illustrative embodiments are discussed below.

In some embodiments, a sealing device to hold pressure between a part of the body, such as an arm or a leg, and a corresponding part of a pressure suit, such as the suit arm or leg, is created by mounting a flexible lip seal within a housing to which pressure suit parts can be mounted. The mounting may be made with conventional pressure suit interface hardware such as a wrist disconnect. The mounting may also be achieved through directly mounting pressure suit components such as bladder and restraint layers to the housing. Such mounting approaches by necessity will be able to hold pressure.

In some embodiments, the interface hardware includes a bearing integrated with the housing, because the seal made between the interface and the skin of the user can limit the free movement of the limb against which the interface is sealed. That is, once the seal is engaged directly with the body and the device is pressurized, the pressurized limb may become substantially immovable. Therefore, a movable bearing may be integrated with the housing, with interface components on the movable bearing race to enable unimpeded motion.

In some embodiments, a harness system may be attached to the interface once the device is pressurized. The harness may help prevent the pressurized suit sub-portion from being pushed off the body by the internal pressure.

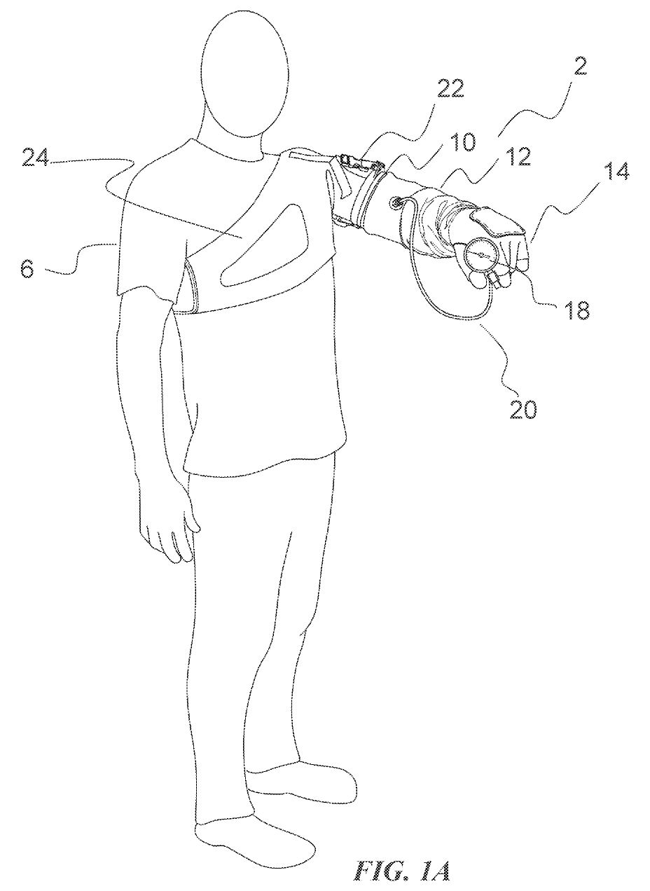

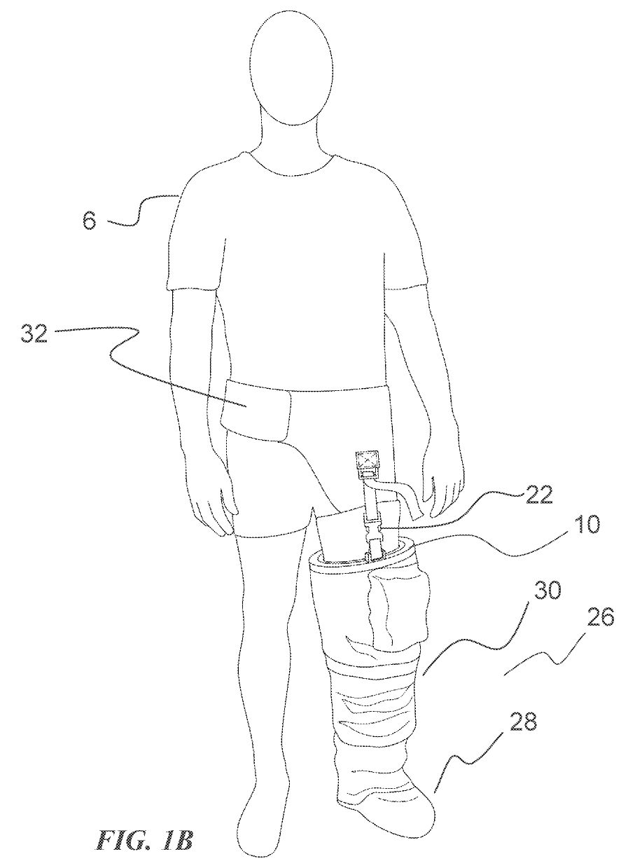

FIG. 1A shows an embodiment of a pressurized partial space suit 2 positioned on an arm of a user 6. In this embodiment, the suit 2 is configured to fit on the arm of a user 6. A seal 10 is connected to a proximal end of the pressurized partial space suit 2. The suit 2 includes a pressurizable air-tight enclosure that retains a pressurized gas. The suit 2 also includes an outer fabric covering 12 to protect the pressurizable air-tight enclosure and provide an outer surface to the suit. The partial space suit 2 includes a glove 14 on a distal end of the suit 2 that provides a protective surface for a portion of the pressurizable air-tight enclosure that envelops the hand of the user 6. A pressure gauge 18 connected to the suit 2 by a pressure tube 20 monitors the internal pressure of the suit 2. The suit 2 is retained on the arm of the user 6 with a shoulder harness 24 (e.g., axial restraint) that, in some embodiments, is mounted on a torso of the user 6 and is attached to a proximal end of the suit 2 via straps and connectors 22.

FIG. 1B shows another embodiment of a pressurized partial space suit 26 positioned on a leg of a user 6. The pressurized partial space 26 suit includes a seal 10 at a proximal end of the partial space suit 26 and a boot 28 at the distal end. The partial space suit 26 includes a boot 28 on a distal end of the suit 26 that provides a protective cover 30 for a portion of the pressurizable air-tight enclosure that envelops the leg and foot of the user 6. The suit 26 is retained on the leg of the user 6 with a hip harness (e.g., axial restraint) 24 that, in some embodiments, is mounted on a torso of the user 6 and is attached to a proximal end of the suit 26 via straps and connectors 22 attached to the seal. Attachment to the hip harness allows the partial space suit 26 to be worn on the body without being pushed off the extremity or body part, in this case the leg, by the pressure inside.

It should be noted that "sealing the proximal end" of the pressurized partial space suit 2 can mean ensuring that the overall suit 2 has been sealed at a location at the proximal end, or between the distal and proximal ends of the suit 2.

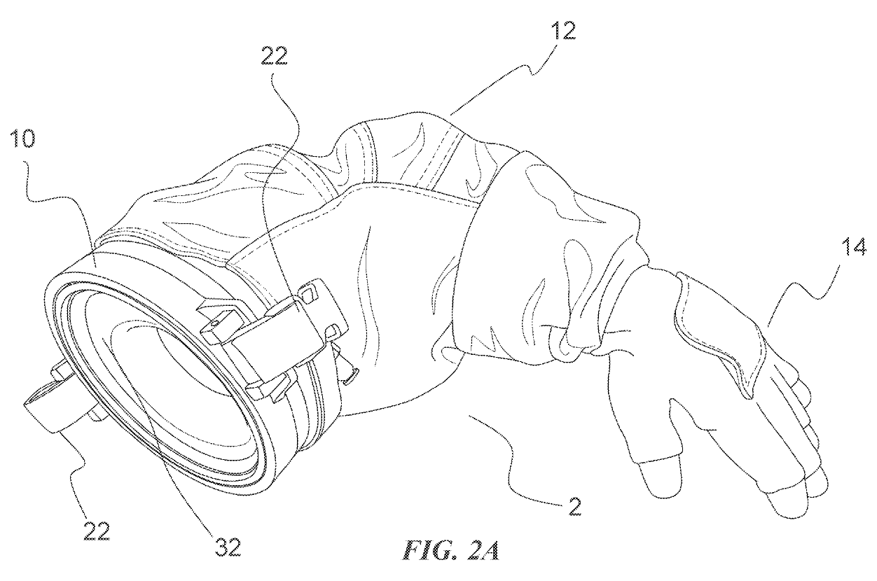

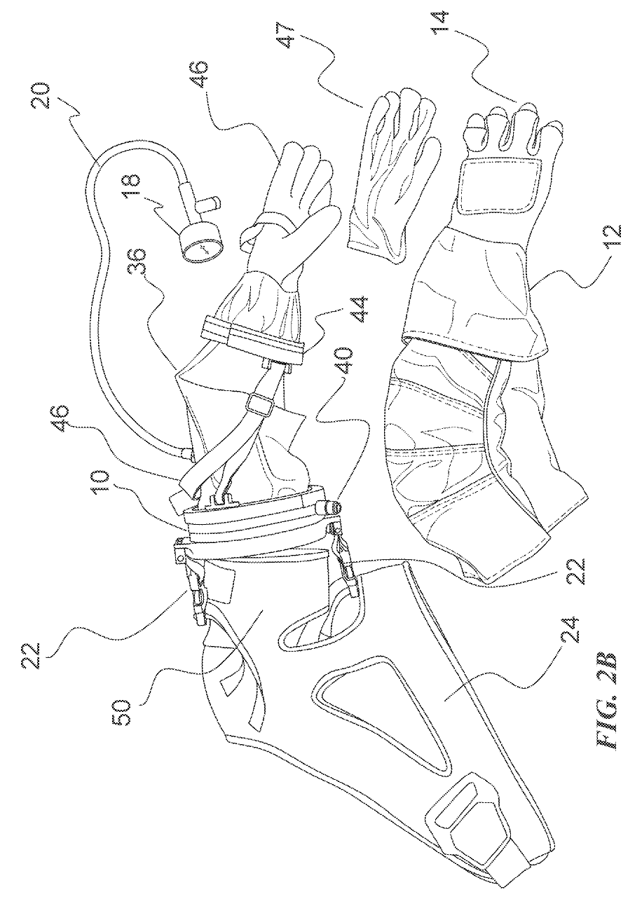

FIG. 2A shows an arm embodiment 2 of a partial space suit. A seal 10 is at a distal end of the arm space suit with a glove 14 at the distal end. Inside of the seal 10, a ring of a flexible material (e.g, flexible lip seal) 32 is positioned inward of a seal housing (e.g., radially inward of, discussed below) . The flexible lip seal 32 comprises a moldable elastomer, such as one or more of silicone, poly-urethane, modified silane polymers, and the like. Straps and connectors 22 are attached to the seal and can be used to secure the suit 2 to an axial restraint, such as a harness mounted on the body of the user. The suit 2 also includes an outer fabric covering 12 is provided to protect the pressurizable air-tight enclosure and provide an outer surface to the suit 2.

FIG. 2B shows drawings of parts of a disassembled prototype pressurized partial space suit 2, according to some embodiments. Shown are a pressure-tight inner structure 36 and an outer fabric covering 12 with a glove 14 at the distal end. The pressure-tight inner structure 36 expands like a bladder when the suit is pressurized, therefore the pressurized partial space suit also includes a restraint layer positioned between the pressure-tight inner structure 36 and the outer fabric covering 12. The restraint layer contains the expanding bladder of the pressure-tight inner structure 36 and provides shape to the expanding pressure-tight inner structure 36. The prototype pressurized partial space suit 2 includes a pressure-tight inner structure 36 on the inside of the suit, a restraint layer on top of the inner structure, and an outer fabric covering 12 on top of the restraint layer and providing the outside surface of the suit 2.

The prototype pressurized partial space suit 2 of FIG. 2B also includes a seal 10. The seal 10 has connector 40 mounted to the seal 10 with an air-tight seal. A pressurizing gas is admitted to and removed from the prototype pressurized partial space suit through the connector 40. The connector 40 may be a valve. It may be a one-way valve, or a two-way valve. The connector may be an air inlet.

In some embodiments, the prototype pressurized partial space suit 2 also includes a distal seal 44 at a distal end of the pressure-tight inner structure 36. The distal seal 44 may provide an air-tight connection between the pressure-tight inner structure 36 and a pressure-tight distal feature, such as an inner glove or an inner boot. The inner glove 46 provides a pressure-tight inner structure for a hand of a user. In some embodiments, the pressure in the inner glove may be different than the pressure in the pressure-tight inner structure between the seal 10 and the distal seal 44. That is, in some embodiments the pressure inside the distal portion of the pressurized partial space suit, e.g., the inner glove or an inner boot, may be higher or lower than the pressure in the pressure-tight inner structure between the seal 10 and the distal seal 44. It may be beneficial for a user to be able to operate their hand in a glove (e.g., a distal portion of the suit 2) with a lower pressure than that required for the pressure-tight inner structure between the seal 10 and the distal seal 44.

In some embodiments, the pressurized partial space suit 26 positioned on a leg of a user 6 may also have an air-tight distal seal that can join an air-tight boot to a pressure-tight inner structure between the seal 10 and the distal seal around a lower portion of a leg of the user.

The inner glove is positioned in the suit under the glove 14 of the outer fabric covering 12. In some embodiments, a cloth glove 47 is worn by a user closest to the skin to improve user comfort while using the prototype pressurized partial space suit 2.

In some embodiments, a pressure gauge 18 is connected to the pressure-tight inner structure 36 of the suit 2 by a pressure tube 20. The pressure gauge 18 monitors the internal pressure of the suit 2. The pressure tube 20 may be fluidically connected to the inner structure 36 by a valve.

In some embodiments, the seal 10 and the distal seal 44 may have at least one strap 46 that connects the two seals to provide structural stability to the prototype pressurized partial space suit 2. The strap 46 may be adjustable in order to fit the length of the suit 2 to the arm of the user.

In some embodiments, the seal 10 may be configured to be able to connect to a full space suit, and/or a body unit of a space suit.

FIG. 2B also shows a shoulder harness 24. The shoulder harness (e.g., axial restraint) 24 has straps and connectors 22 that can be attached to the seal and can be used to secure the suit 2 to the axial restraint. In some embodiments, the shoulder harness includes an adjustable sleeve portion 50 that can be mounted to an upper arm of the user. Attachment of the shoulder harness 24 to the can allow sustained operation in multiple orientations.

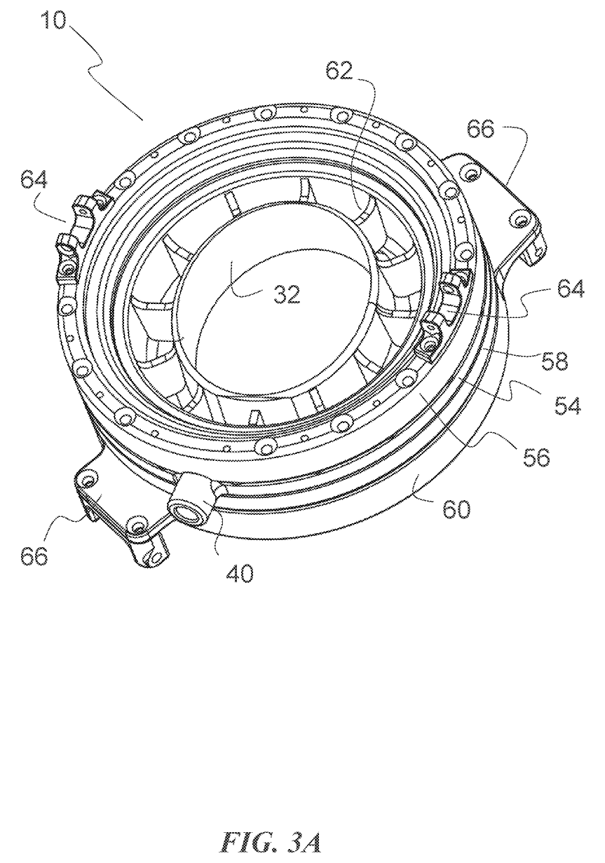

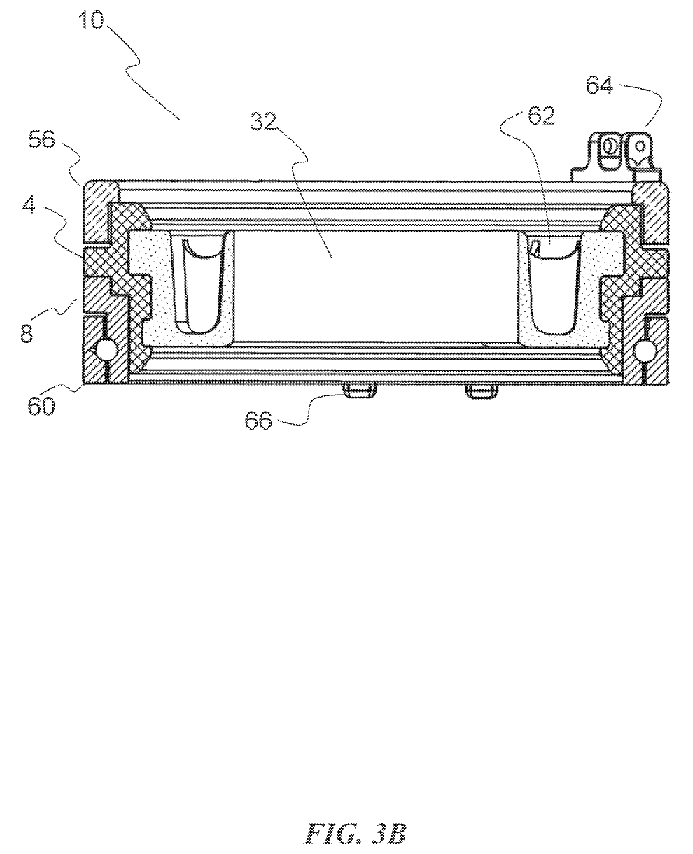

FIG. 3A shows an embodiment of a seal 10 having a seal housing 54, a soft goods clamp 56, a bearing inner race 58 and outer race 60, a flexible lip seal 32 having ribs 62, and restraint strap attachment brackets 64. A valve 40 (e.g., air inlet) enables pressure to flow past the seal into the pressurized volume enabled by the seal. The flexible lip seal 32 is radially inward of the seal housing 54. The flexible material of the flexible lip seal 32 is configured to conform to the contours of the inside surfaces of the seal 10. A second attachment bracket 66 enables connection of the seal 10 to a body harnessing system 24, including straps and connectors 22, that prevents the pressurized partial space suit 2 components from being pushed off the extremity or the body by the pressure inside the enclosed volume.

FIG. 3B shows a section view of the seal 10 with seal housing 54, a soft goods clamp 56, a bearing inner race 58 and outer race 60, a flexible lip seal 32 having ribs 62, and a restraint strap attachment bracket 64. A second attachment bracket 66 enables connection of the seal 10 to a body harnessing system 24, including straps and connectors 22, that prevents the pressurized partial space suit 2 components from being pushed off the extremity by the pressure inside.

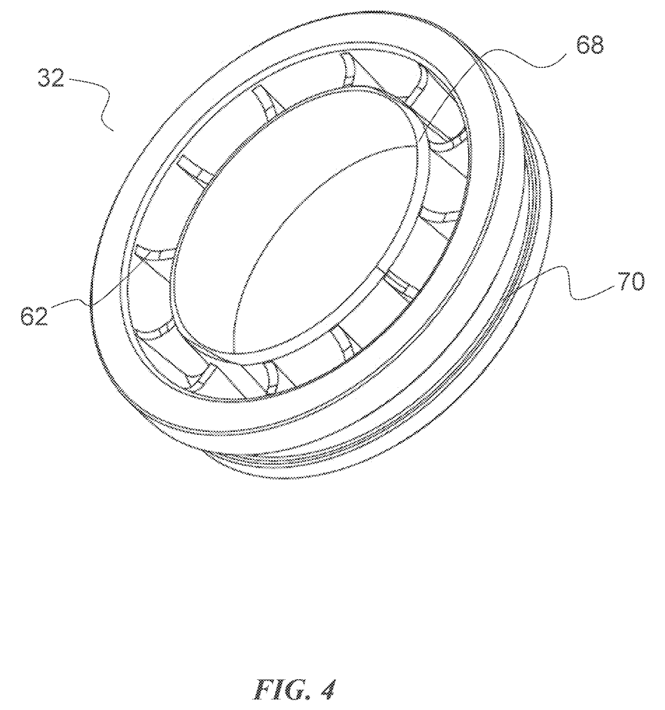

FIG. 4 shows the flexible lip seal 32 with ribs 62 that help prevent inversion of the lip seal 32 when the suit 2 is pressurized. The ribs 62 are on the pressurized side of the seal 32, whereby the pressure urges the lip 68 tighter against the body part that the seal circumscribes or encircles. A retaining feature 70 helps keep the lip seal 32 from being forced out of the main body of the seal 10 in which the flexible lip seal 32 is installed, when the pressurized partial space suit 2 is pressurized.

### Examples

### Example 1. A First Prototype Glove Simulation System

The first prototype used a single layer airtight glove with a modified pressure cuff and pressure regulation system. Key advances resulting from this prototype include validation of the fundamental portability concept, including realistic pressure-induced resistance for hand and finger motion. The wrist seal used a tight-fitting, pressure-energized rubber cuff that sealed against the arm when the glove was pressurized. This was effective at holding pressure and fit a wide variety of arm sizes, but the seal was not comfortable enough to wear under pressure for extended periods of time. Additionally, deflection in the seal that resulted from flexing and extending the fingers and performing certain grasping tasks periodically initiated the inversion and leakage of the seal.

FIG. 5 shows a block diagram of the first prototype glove simulation system including a pressurized air source 70, a regulator and pressure gage 72, a pressure port 74, a forearm seal 76, and a pressurized glove 78.

The first prototype with its simple rubber dam at the wrist proved the concept, allowing the glove pressure layer to be pressurized with the rubber dam sealing successfully at the wrist. When fitted with a makeshift pressure restraint layer in the form of a leather work glove, subjects were able to demonstrate and experience reduced dexterity and tactility when attempting to manipulate objects. Due to the thin rubber used as the pressure dam, the seal would invert and leak pressure over approximately 2 PSI, but the baseline concept was successfully demonstrated. An upgraded version of Prototype 1 was constructed that attached the glove to a large piece of reinforced hose to enable the arm to be pressurized from the upper arm down. A larger dam was constructed of flat rubber in a donut shape to seal against the middle of the upper arm, and the concept was successfully demonstrated again at pressures up to approximately 2 PSI but with less leakage at the air dam. Basic restraints were implemented with tubular nylon webbing to prevent the pressure from displacing the glove distally past the hand, and a simple harness was constructed to prevent the entire assembly from advancing itself down the arm when pressurized.

### Example 2. A Second Prototype Glove Simulation System

The second prototype system had two configurations, the first of which was a large clear tube that enabled rudimentary measurements to be made to help qualify physical effects of the pressurized seal on circulation and stamina, and the second of which was a lower arm and glove pressure garment mockup that substantially increased the accuracy of the simulation. Some features of the pressure garment mockup included an outer fabric layer to serve as a combined TMG and restraint layer for the lower arm, separate pressure restraint and outer TMG mockup layers for the glove, an improved proximal arm seal, and supporting structure attaching the assembly via adjustable quick-disconnect straps to the body via a neoprene shoulder brace suitable for longer-duration field use. With the ultimate goal being to provide a reliable pressure sealing approach that can interface with Class III lower arms and/or gloves, the mockup components were intended to both provide a higher fidelity overall proof of concept and to pave the way for higher quality pressure garment simulation components that can be provided at lower cost and better availability than Class III hardware in the future.

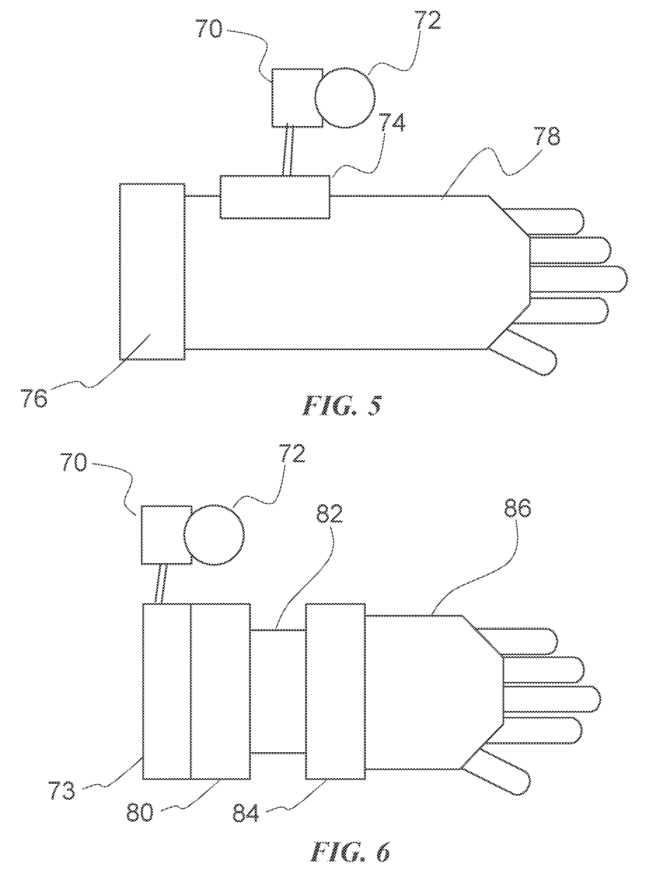

FIG. 6 shows a block diagram for the second prototype glove simulation prototype system including a pressurized air source 70, a regulator and pressure gage 72, an arm bearing and attachments to a shoulder brace 73, pressure dam 80, a pressurized tube 82, a wrist flange 84, and a pressurized glove 86.

Prototype 2 included two versions of the arm seal. The first was a simple silicone dam constructed from a repurposed silicone prosthetic sleeve. The second was a molded silicone seal made by 3D scanning the test subject’s upper arm and designing and printing molds that yielded a custom fit pressure-energized seal. Due to the tendency of simpler flat rubber dams to invert at or before pressures in the 4.3 PSI range, the custom seal was designed with thicker walls and a more explicit annulus for the pressure in the tube or pressure garment to energize the seal. 2-part silicone molding mix was used with 3D printed molds designed to work around the main body of the pressure cuff, such that the seal was molded directly into the part to which it needed to seal and which physically retained it.

The second prototype’s construction allowed for several specific tests to be performed, yielding results indicative of overall concept viability. The second prototype had two configurations, a clear plastic tube (described below) and a lower arm/glove assembly (shown in FIG. 6). The two prototypes were used to qualitatively evaluate blood flow restriction, Rate of Perceived Exertion (RPE) during simple grasping and elbow flexion movements, attachment to the arm via a modified shoulder brace, and overall comfort.

### Blood Flow Restriction and Safety

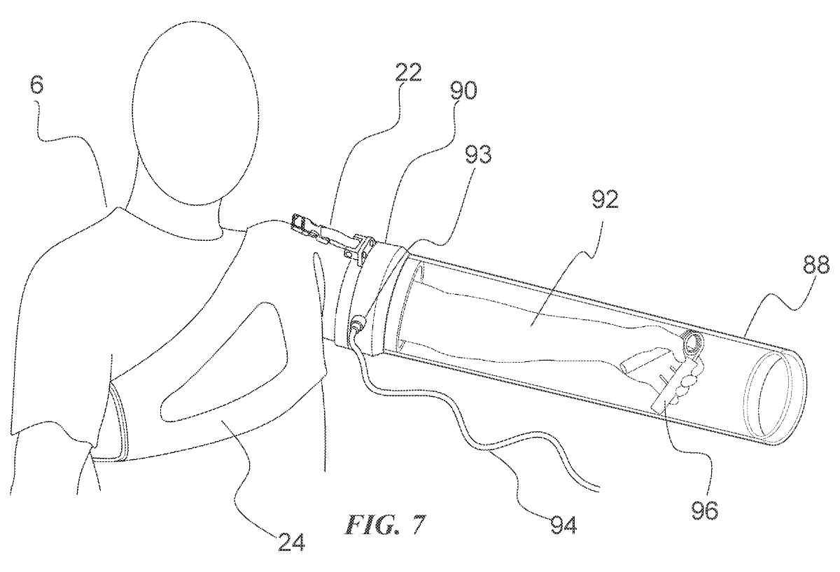

FIG. 7 shows a prototype testing system using a clear plastic tube attachment 88 with the custom pressure seal 90. Using the second prototype’s clear plastic tube attachment 88 with the custom pressure seal 90, a valve 93 and a pressure tube 94, a first test was performed with the subject’s arm 92 inside the tube 88 with the system pressurized through the pressure tube 94 and a pulse oximeter on the subject’s finger. During 10 minutes of pressure at 4.3 PSI, the pulse oximeter did not register a blood oxygen level below 96%, indicating that under static conditions, blood flow did not appear to be substantially impacted.

A second test was performed to qualify the impact of the pressurized arm seal 90 on blood flow restriction by performing repeated squeezing tasks with and without the system pressurized. A baseline performance was established by having the subject 6 squeeze a 50 lbs nominal force grip strength squeezing spring 96 to failure, with the arm 92 and grip strength spring 96 inside the apparatus 88 and with the arm through the seal 90 but without pressure applied. The subject was able to achieve 51 full sequential grasps of the strength spring 96 with no more than a 1 second pause between any grasp, with a full grasp defined as having the metal handles of the grip device touch.

After a rest period of 1 hour separated from the apparatus 88 to allow full recovery, the system was donned again and pressurized to 4.3 PSI. With the system 88 pressurized, the subject achieved a maximum of 39 full sequential grasps, with the subject noting that the RPE required to complete a grasp ramped up significantly faster than without the system pressurized. With the decrease in sequential grasps achieved and the noted increase in the rate of fatigue, it was concluded that the blood flow restriction imparted by the system is by no means negligible.

### Rate of Perceived Exertion (RPE) during Grasping and Elbow Flexion

Without a glove box available during testing to provide immediate A/B tests, comparative RPE to a more traditional glove simulation approach was not able to be assessed. However, the test subject noted a substantial increase in the RPE required to perform grasping tasks and elbow flexion at all pressures above approximately 1.5 PSI, with the RPE increasing approximately linearly with imposed pressure. Tactility was noted to substantially decrease when attempting to pick up, manipulate and grasp objects such as a pressure gauge and operating the pressure regulator with the pressurized glove 86. It was noted that the pressure layer used was rubber membrane adapted from industrial glove boxes and not a rubber-coated woven fabric, and that the change in volume to the pressurized arm and glove assembly shown in FIG. 6 that resulted from hand grasping and elbow flexion was increasing the pressure in the system by as much as 1 PSI during certain motions.

### Arm Attachment via Shoulder Brace

To prevent the prototype testing system 88 from advancing itself distally down the axis of the arm 92 while under pressure, a harness 24 (e.g., axial restraint) was constructed by attaching straps and connectors 22 between the harness 24 and the prototype testing system 88. The harness 24 was successful in retaining the assembly 88 on the arm 92, with some slippage noted after repeated elbow flexions that likely resulted from the compliant nature of the neoprene that the shoulder brace assembly was made from. Because the harness assembly 24 was attached to the pressurized arm through a bearing that mimics the distal bearing in the shoulder assembly, rotation of the arm around the axis of the humerus bone was enabled even when the system was pressurized.

### Overall Comfort & Safety

To assess the high-level viability of implementing a system like this in regular use, qualitative notes were taken on overall comfort with a view to the possibility of longer duration use during EVA trainings, operational concept development efforts, and other tests. While the test subject has minimal time using glove boxes and no experience wearing pressurized suits to compare against, efforts were made to differentiate the challenge and discomfort that resulted from performing actions impeded by a pressurized suit in general from system-specific discomforts such as contact points from the buckles on the shoulder harness and blood flow restriction from the pressure cuff.

Significant discomfort that resulted from system-specific attributes resulted from the increased fatigue rate and RPE needed to perform tasks when the system was pressurized. It is likely that this is resulting from blood flow reduction imposed by the pressurized cuff. While this was a primary concern from the outset, numerous studies have shown that performing some low intensity physical actions while under intentional blood flow restriction yields improved gains in muscle strength and size compared to performing the same higher intensity actions with unimpeded blood flow.

The embodiments of the invention described above are intended to be merely exemplary; numerous variations and modifications will be apparent to those skilled in the art. Such variations and modifications are intended to be within the scope of the present invention as defined by any of the appended claims.

What is claimed is:

1. A pressurized partial space suit comprising:
a pressurizable air-tight enclosure configured to be positioned on a body part of a user, the pressurizable air-tight enclosure having a proximal end and a distal end;
a seal configured to seal the pressurizable air-tight enclosure to the user, the seal comprising:
a flexible lip seal configured to circumscribe the body part of the user, the flexible lip seal configured to seal the pressurizable air-tight enclosure the body part of the user to maintain a pressure inside the pressurizable air-tight enclosure;
a connectable seal housing having a connector in fluidic communication with the pressurizable air-tight enclosure to maintain the pressure in the pressurizable air-tight enclosure, wherein:
the flexible lip seal is inward of the seal housing; and
the pressurizable air-tight enclosure s removably attached to the seal.

2. The pressurized partial space suit of claim 1, wherein the distal end of the pressurizable air-tight enclosure is enclosed.

3. The pressurized partial space suit of claim 1, wherein:
the seal is a first seal; and
further comprising:
a second seal on the distal end of the pressurizable air-tight enclosure, the second seal configured to seal the distal end of the pressurizable air-tight enclosure to a distal portion of the body part of the user to maintain the pressure inside the pressurizable air-tight enclosure.

4. The pressurized partial space suit of claim 1, wherein the flexible lip seal comprises a sleeve comprising a compliant solid material.

5. The pressurized partial space suit of claim 1, wherein the pressure is between 3 PSI and 15 PSI.

6. The pressurized partial space suit of claim 1, wherein the pressure is between 3.5 PSI and 5.5 PSI.

7. The pressurized partial space suit of claim 1, further comprising:
an axial restraint configured to be attached to the seal via attachment straps such that the axial restraint retains the pressurizable air-tight enclosure on the body part of the user.

8. The pressurized partial space suit of claim 1, wherein the body part is an arm.

9. The pressurized partial space suit of claim 3, wherein the distal end of the pressurizable air-tight enclosure comprises:
a glove; or
a second seal.

10. The pressurized partial space suit of claim 9, wherein the proximal end of the pressurizable air-tight enclosure is configured to form a seal with a portion of the arm:
between an elbow and a shoulder of the user, or
between an elbow and a wrist of the user.

11. The pressurized partial space suit of claim 7, wherein the axial restraint comprises a shoulder brace.

12. The pressurized partial space suit of claim 1, wherein the body part is a leg.

13. The pressurized partial space suit of claim 12, wherein the distal end of the pressurizable air-tight enclosure comprises:
a boot; or
a second seal.

14. The pressurized partial space suit of claim 13, wherein the proximal end of the pressurizable air-tight enclosure is configured to form a seal with a portion of the leg:
between a knee and a hip of the user, or
between the knee and an ankle of the user.

15. The pressurized partial space suit of claim 14, wherein the axial restraint comprises a hip brace.

16. The pressurized partial space suit of claim 1, wherein the seal comprises one or more bearings.

17. The pressurized partial space suit of claim 16, wherein the one or more bearings comprise one or more ball bearings.

18. A seal comprising:
a seal housing forming a circular structure;
a flexible lip seal configured to circumscribe a body part of the user, the flexible lip seal inward of the main structure and configured to seal a pressurizable air-tight enclosure to a portion of the body part of a user to maintain a pressure inside the pressurizable air-tight enclosure;
a soft goods clamp configured to retain a flexible portion of the pressurizable air-tight enclosure;
a bearing inner race comprising one or more ball bearings;
a bearing outer race comprising one or more ball bearings; and
an air inlet configured to enable fluidic communication between an air source and the pressurizable air-tight enclosure, wherein the soft goods clamp, the bearing inner race, the bearing outer race, the air inlet, and the flexible lip seal are configured to fit together to form the seal.

19. The seal of claim 18, further comprising:
one or more restraint strap attachment brackets; and
one or more straps and connectors.

20. The seal of claim 18, wherein the air inlet comprises a valve.

21. The seal of claim 18, wherein the flexible lip seal comprises:
two or more ribs ;
a lip; and
a retaining feature, the retaining structure.
